(19) United States
(12) Patent Application Publication
(10) Pub. No.: US 2014/0224350 A1
(43) Pub. Date: Aug. 14, 2014

(54) Water Shut Off Device

(71) Applicant: Jitendra Patel, Wappingers Falls, NY (US)

(72) Inventor: Jitendra Patel, Wappingers Falls, NY (US)

(21) Appl. No.: 13/962,157

(22) Filed: Aug. 8, 2013

Related U.S. Application Data
(60) Provisional application No. 61/742,513, filed on Aug. 13, 2012.

(51) Int. Cl. G05D 7/06

(52) U.S. Cl. CPC G05D 7/0623
USPC 137/78.1

(57) ABSTRACT

The present invention detects the presence of occupancy or activity in one or more locations of a building and remotely takes action to shut off the flow of water by keeping the main shutoff valve to the building closed when no activity or occupancy has been detected for a predetermined amount of time and opening this valve when activity has been sensed. Motion sensors are placed throughout the building in areas commonly traveled during occupancy/activity. The system is designed such that motion sensors have a means to communicate with a motorized water valve each time motion is sensed to control the opening and closing of the water valve. The means of communication between the one or more motion sensors and the motorized water valve may be a wireless signal such as a radio signal generator which transmits a radio signal to a receiver integrated with the motorized water valve.

### CROSS-REFERENCE TO RELATED APPLICATIONS

The present application relates to, and claims priority to U.S. Provisional Patent Application Ser. No. 61/742,513 filed on Aug. 8, 2012, which is entitled “An automatic water shut-off system consisting of a combination of radio signal generator/transmitter using an occupancy sensor and a motorized valve equipped with radio signal receiver to automatically turn water supply ON and OFF based upon occupancy in home, office or a building.” The content of this priority application is incorporated herein in its entirety by reference.

### TECHNICAL FIELD

This invention relates to devices for the prevention of water leaks and flooding of any type of building, whether residential or commercial. These devices prevent water leakage in a building during long or short term periods of non-occupancy or reduced activity within the building.

### BACKGROUND

An undetected water leak in a home or commercial building can cause extensive property damage if it is not caught in a timely manner. The damage to buildings caused by flooding due to failure in the water supply system can cost millions of dollars to repair. Broken water lines due to freezing, normal wear-and-tear, or the failure/malfunctioning of appliances such as hot water tanks, washing machines, and dishwashers can cause internal flooding. This flooding, even when caused by a minor leak, can be responsible for extensive property damage to the interior of a building. Such problems can be further exacerbated in multi-story structures where a leak in one unit can lead to leaking or flooding in several other units. Homeowners who are away from their property for any amount of time run the risk of returning to a flooded home that can require expensive repairs.

One way to stop the problem of leaking water during non-occupancy or low activity is to shut off the main water supply line to a home or property. Generally, the main water supply line is equipped with a manual shutoff valve located at the point where the water enters the home. To prevent an undetected leak from causing damage, homeowners may manually shut off the main water valve to the home each time they are away for an extended or short period of time. However, this safety method is inconvenient, cumbersome and impractical. Moreover, many times property owners forget to shut off the main water valve, therefore circumventing the usefulness of this safety method.

There also exist water leak detection devices in the market. This prior art consists primarily of water leak detection devices which are designed to detect water and automatically shut off an appliance or the main water line in the event water is detected by the sensors. A significant amount of this prior art utilizes sensing devices of various types and configurations which are confined to a particular area or locality where water is assumed to collect in the event of a leak. Representative of this prior art are U.S. Pat. No. 4,297,686 (Tom), U.S. Pat. No. 4,020,478 (Hatfield), U.S. Pat. No. 3,562,731 (Hsu), U.S. Pat. No. 3,200,388 (Uhlig) and U.S. Pat. No. 3,770,002 (Brown). In such prior art devices, the effectiveness of detection is severely limited by the fact that the water must reach the sensor first before an alarm can be sounded. By this time, a slow leak can cause substantial damage to the interior of a building before being detected by a sensor. Therefore, a significant problem with these devices is that once the presence of water is sensed, a large amount of damage has already been done to the interior of the building, such as damage to rugs, carpeting, leaking through cracks between boards on a wooden floor and potentially to the ceiling and floors below, and any other structure or item left on the ground. A need therefore exists for a system which prevents damage to all areas of a building and is easy to operate while still being effective in preventing flooding caused by leaks.

The present invention detects the presence of occupancy or activity in one or more locations of a building and remotely takes action to shut off the flow of water by keeping the main shutoff valve to the residence closed when no activity or occupancy has been detected for a predetermined amount of time and opening this valve when activity has been sensed. Motion sensors are placed throughout the building in areas commonly traveled during occupancy/activity. The system is designed such that motion sensors have a means to communicate with a motorized water valve each time motion is sensed to control the opening of the water valve. The means of communication between the one or more motion sensors and the motorized water valve may be a wireless signal such as a radio signal generator which transmits a radio signal to a receiver integrated with the motorized water valve.

In this way, the present invention provides property owners with an alternative to manually shutting off the main water supply during each period of non-occupancy or non-activity such as at night while also overcoming the problems associated with the above-mentioned prior art leak detection devices. The present invention will save millions of gallons of water that are currently being wasted due to the leaking of faucets and fixtures in any building during periods of non-occupancy or low activity.

### SUMMARY

In one general aspect there is provided a for preventing undetected leaks in the plumbing pipes and fixtures of a building made up of a motorized valve connected to a water supply line such that the water flows through the motorized valve when the valve is in an open position, one or more motion-activated wireless transmitters which transmit a wireless signal to a controller, the controller being capable of receiving wireless signals from the one or more transmitters and the controller being electrically coupled to the motorized valve, and a power supply source for providing power to the one or more motion activated transmitters, the controller and the motorized valve.

Embodiments of the system may include one or more of the following features. For example, the system may include an embodiment wherein the motorized valve remains in the closed position until the one or more motion-activated wireless transmitters transmit a wireless signal to the controller upon sensing motion in the building, whereby when the controller receives the wireless signal from the one or more transmitters, the motorized valve moves from the closed position to an open position.

The system may include an embodiment wherein after the motorized valve changes to the open position, the valve remains in the open position for a predetermined amount of time and wherein after the motorized valve has remained in the open position for the predetermined amount of time, the valve closes unless the controller receives wireless signal from the one or more motion activated wireless transmitters. The predetermined amount of time may be between about 5 minutes to about 3 hours.

The system may comprise a second motorized valve and/or a water softening device. The system may include an embodiment wherein the controller further includes a Wi-Fi enabled receiving device to enable remote communication with a smart phone, laptop, CPU or other electronic device. The system may further include a temporary override option which serves to keep the motorized valve in an open position regardless of the motion detected by the one or more motion-activated wireless transmitters.

In a second general aspect there is provided a device that is made up of a motion-activated electrical plug-in device having a motion sensor, a radio signal transmitter and prongs designed to plug into an electrical outlet such that when motion is detected by the motion sensor, the electrical outlet energizes the radio signal transmitter to transmit radio signal to a receiver integrated with the motorized water valve and the motorized water valve changes from a closed position to an open position.

Embodiments of the device may include one of the following features. For example, the device may include an embodiment wherein the motion-activated electrical plug-in device further comprises at least one electrical socket. The device may be such that the radio signal transmitter is a separate unit which may be plugged into the electrical socket of the motion-activated electrical plug-in device. The electrical plug-in device may be powered by a battery. There may be a means to turn on and off the radio signal transmitter.

The device may include a motorized valve which is programmed to remain open for a predetermined amount of time, such as about 5 minutes to about 3 hours. The device may include a Wi-Fi-enabled receiving device to enable remote communication with a smart phone, laptop, CPU or other electronic device. The device may also be designed to communicate wirelessly to at least a second motorized valve. The device may include a temporary override option which serves to keep the motorized valve in an open position regardless of the motion detected by the motion sensor. The device may also include an additional sensor such as a temperature sensor, a water leak sensor and a humidity sensor.

### DESCRIPTION OF THE DRAWINGS

FIGS. 1-3 illustrates one embodiment of the invention in which a radio signal generator/transmitter is used in conjunction with a motion activated electrical outlet device 100

FIG. 4 illustrates the motorized valve stem of the present invention installed as a part of the main water line pipe.

FIG. 5 illustrates a control module for the system of the present invention.

FIG. 6 illustrates a pair of motorized valve stems for use in connection with a water softening device.

FIG. 7 illustrates one embodiment of the receiver/controller which is integrated with the motorized valve of the present invention.

FIG. 8 illustrates another embodiment of the receiver/controller unit for use in connection with a water softening device.

FIG. 9 illustrates another embodiment of the receiver/controller unit for use in connection with a water softening device.

FIG. 10 lists the desired features of the invention according to one embodiment of the present invention.

FIG. 11 provides the factors and conditions involved in controlling the motorized valve of the present invention.

FIG. 12 illustrates two embodiments of the radio signal generator/transmitter which is integrated with a motion sensor.

### DETAILED DESCRIPTION

The present invention detects the presence of occupancy or activity in one or more locations of a building and remotely takes action to shut off the flow of water by closing the main shutoff valve to the residence when no activity or occupancy has been detected for a predetermined amount of time. The default position of the motorized valve is therefore the closed position and it is only when activity and/or occupancy has been detected that the motorized valve will switch to the open position to allow water to be supplied to the building. This system is advantageous from the prior art because it prevents the chance of leaks and flooding to occur when there is limited activity in the building in which case there is a reduced awareness and ability to monitor water leaks and emergencies. Motion sensors may be placed throughout the building in areas commonly traveled during occupancy or in places where water will be used, such as in bathrooms, the kitchen and/or near household appliances.

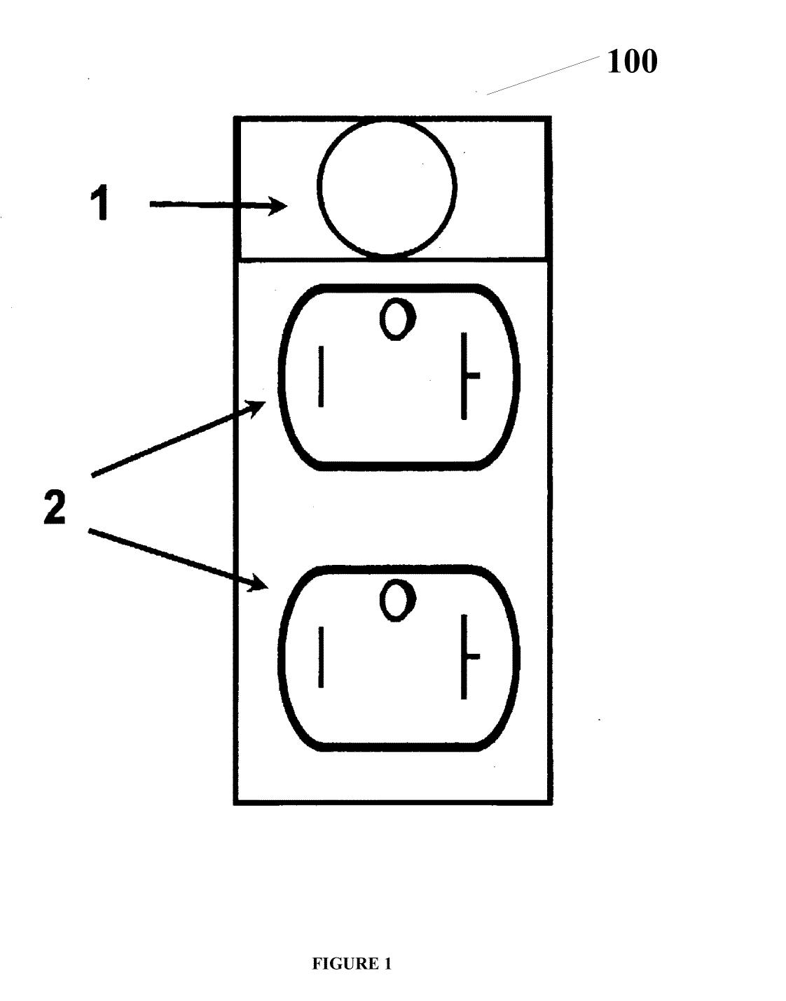

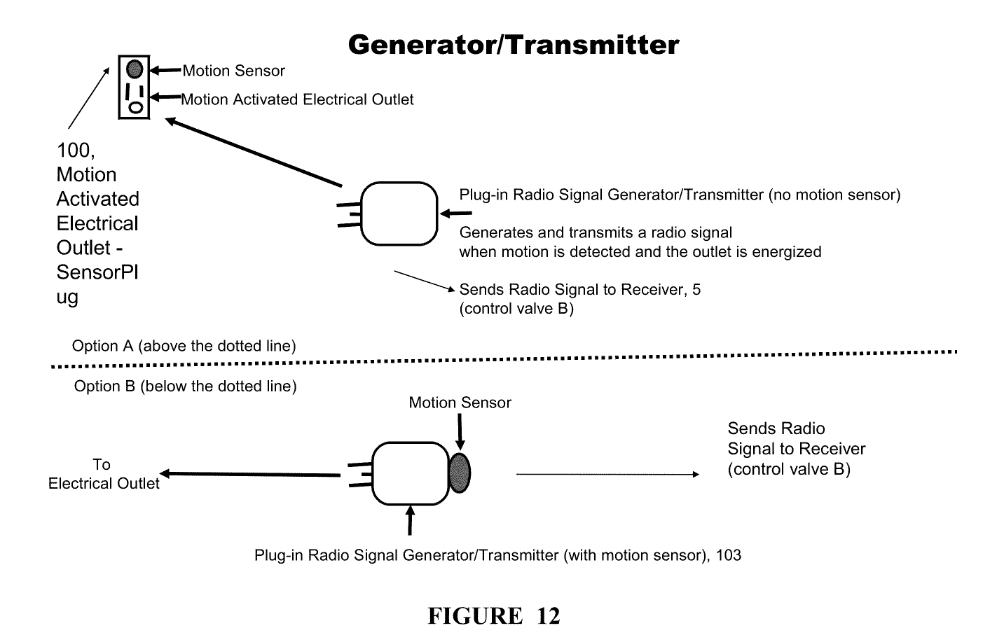

FIG. 1 shows one embodiment of the invention in which a radio signal generator/transmitter is used in conjunction with a motion activated electrical outlet device 100. An example of the device 100 is explained in detail in U.S. Pat. No. 5,673,022 (Patel) which is herein incorporated by reference in its entirety. The motion activated electrical outlet device 100 may be designed to plug into any standard or non-standard electrical outlet and may be equipped with at least one motion sensor 1. The electrical outlets 2 are therefore motion activated (i.e., the outlets are energized only upon the sensing of motion by motion sensor 1). As is shown in FIG. 12, a plug-in radio signal generator and/or transmitter 101 may be connected to the motion activated electrical outlet device 100 such that a radio signal may be generated when the outlet 2 is energized as a result of motion sensor 1 being activated. The radio signal may be sent to a receiver 102 which is integrated with a motorized valve controlling the main water line for the building.

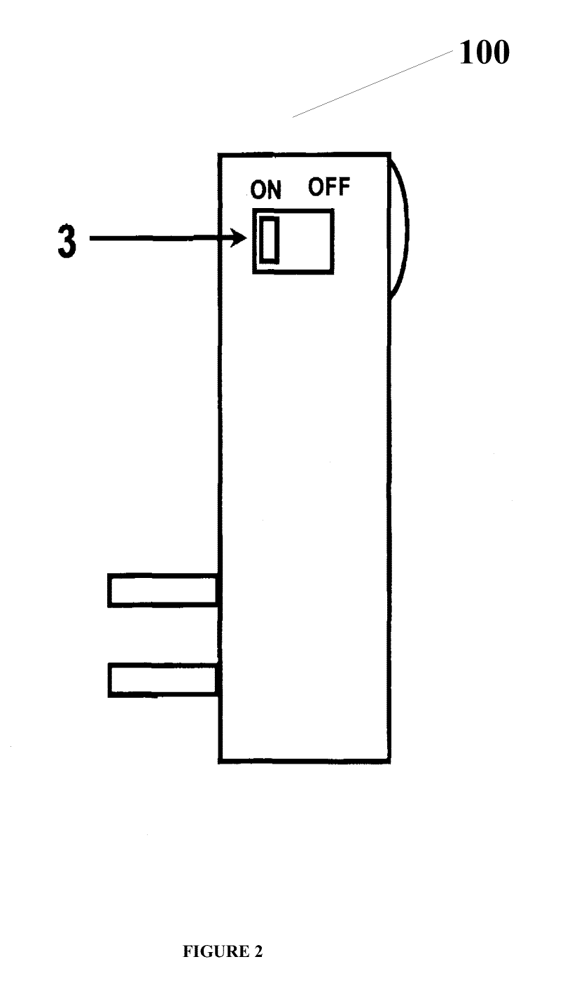

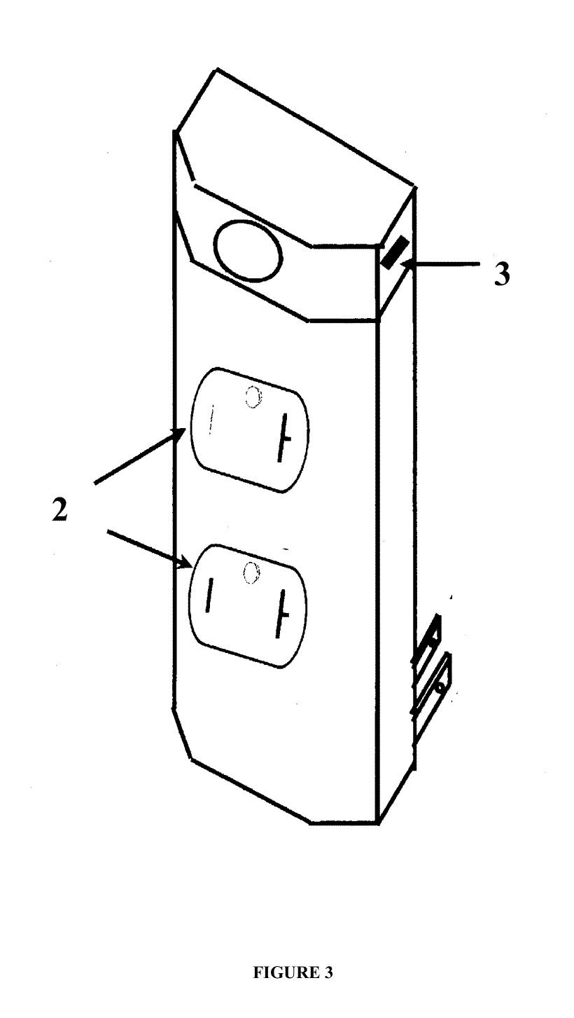

Switch 3 shown in FIG. 2 functions as a means for turning the radio signal on and off so that the user may choose whether radio signal transmission is desired to control the water flow in the building. The switch 3 is illustrated purely as an example and is not meant to limit the invention in any way. Other means of turning the radio signal on and off are a slide switch or a push button. In one embodiment, the motion activated electrical outlet device 100 may be designed such that electricity from the electrical outlets 2 may be cut or turned off after a desired time of non-use in order to save energy. FIGS. 2 and 3 provide a side and perspective view of the motion activated electrical outlet device 100.

The motion activated electrical outlet device 100 having a switch 3 provides advantages such as allowing a user to decide when and where to use the water shut off feature. The device is quite versatile in that the user may choose to turn the devices on and off and may be placed in electrical outlets throughout the building based on the activity in the house at various points in the day. For example, the user may prefer to keep the devices plugged in and switched on during normal periods of activity, but during long periods of absence, the user may only keep one or two devices 100 switched on in the foyer or entrance of the building in order to save energy.

In another embodiment, a plug in radio signal generator and/or transmitter is shown in FIG. 12 which includes a built in motion sensor. This device 103 is different from the plug-in radio signal generator and/or transmitter 101 in that the device 103 contains a motion detector while the device 101 must be plugged into the motion activated electrical outlet device 100 in order to generate a radio signal based on the detection of motion. The device 103 may be plugged into any standard electrical outlet in the building and can also be equipped with a switch as is present in the motion activated electrical outlet device 100.

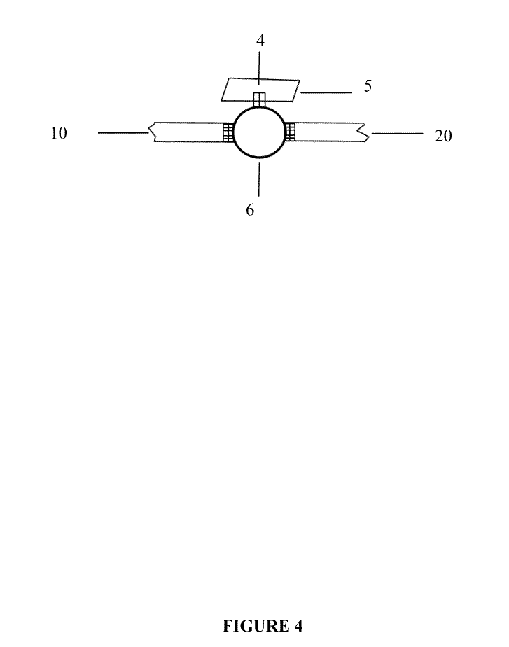

In either embodiment shown in FIG. 12, when motion is detected by the motion sensor, the plug in unit will generate and transmit a radio signal. This radio signal is then received by a radio signal receiving unit located in and/or integrated with the water supply line of the building. The radio signal receiving unit may comprise a motorized valve 6, a valve stem 4, and a radio signal receiver 5 as shown in FIG. 4. FIG. 4 is a side view of the motorized valve 6 installed between water inlet line 10 and building water supply line 20. The motorized valve stem 4 may be electrically operated whenever radio signal is received by the radio signal receiver 5. The valve stem 4 may also be manually operated when needed.

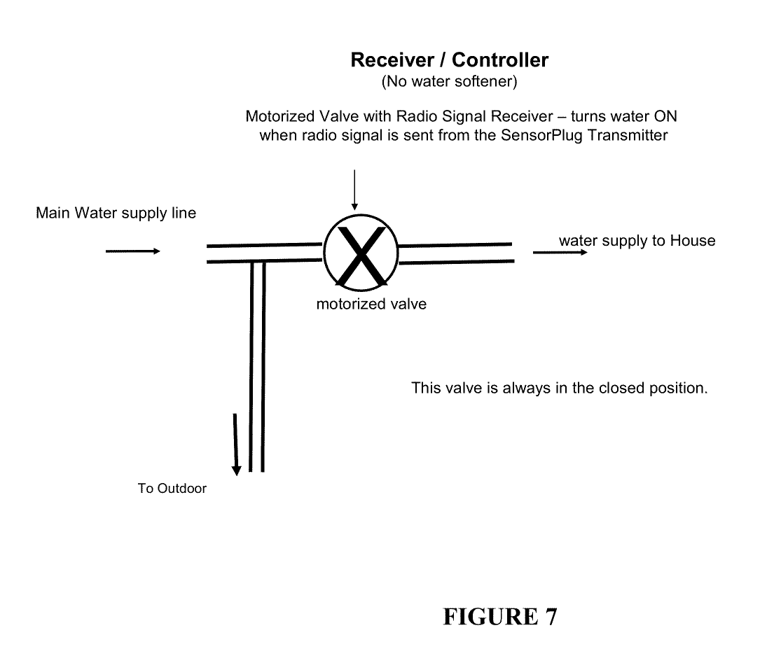

FIG. 7 illustrates the location of the motorized valve in the water supply line when a water softener device 11 is not implemented in the system. In one embodiment, the valve remains in the closed position such that the default position of the water valve is closed and the valve is only turned to the open position when the radio signal receiver 5 detects radio signal from the radio signal generator and/or transmitter. The valve can be programmed to remain open for a predetermined amount of time to allow the user to use the water supply in the building. For example, a user may wish to turn on an appliance such as a dishwasher before retiring for the day and can therefore do so by turning on the appliance and setting the predetermined amount of time to be the length of the longest cycle for an appliance in the user's home. Alternatively, the system may be designed such that the user may notify the system that an appliance is in use and that the user wishes to keep the main water supply open until the appliance has completed its cycle. This can be done by the simple touch of a button or voice activated control by the user, such as through the user's smart phone application or home monitoring system.

In this way, the motorized valve 6 remains in the closed position so long as no motion or occupancy is detected in the building for a predetermined amount of time. Because the default position of the valve is closed, this system is extremely effective in preventing leaks in any part of the plumbing of a building. This is a key difference between the present invention and the prior art, which are based on a default “on” or “open” position for the main water line valve. In the prior art, when a leak is detected, a local or the main valve is shut or closed, whereas in the present invention, leaks are altogether avoided by not allowing water to be available except when the building is occupied or activity is sensed. The presence of compromised sections or parts of the plumbing system of a building can therefore be better monitored and discovered because a leak will occur only when there is activity in the building and therefore the building is occupied.

In another embodiment, the present invention can be combined with water sensor or leak detection devices placed in areas where leaking is likely to occur. In this variation, the motorized valve 6 may be programmed to receive radio signals from either devices 101 and/or 103, as well as water sensors placed on or near the floor to detect leaks.

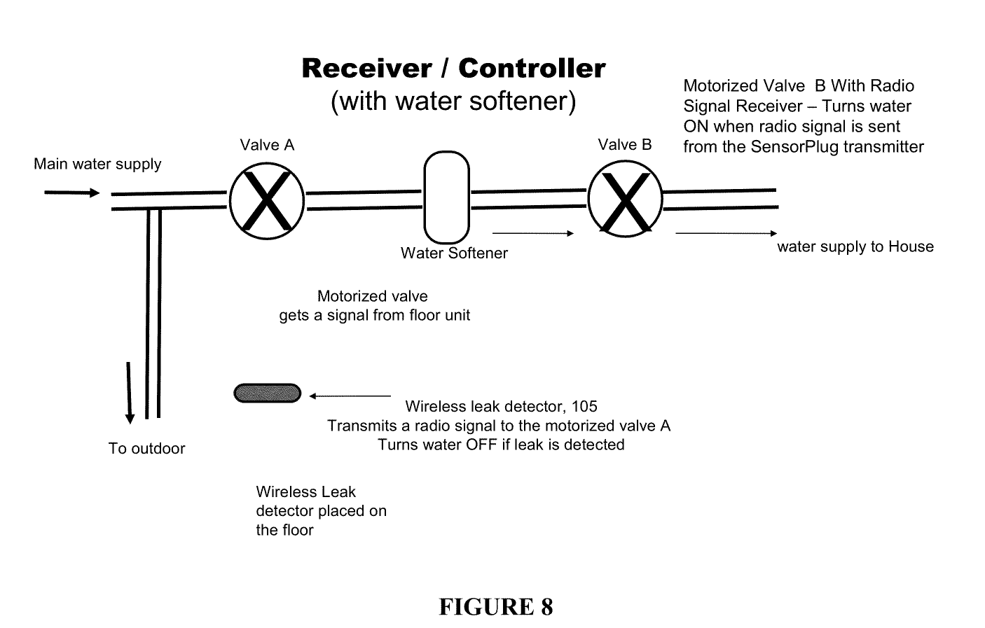

FIG. 8 illustrates an embodiment wherein a water softener is required to produce soft water for the building. Since some water softeners are designed to regenerate at points in the night, the system must have a water supply available to regenerate the resin bed regardless of occupancy or movement in the building. To accommodate this situation, a second motorized valve shown as valve A in FIG. 8 may be placed in the water supply line in order to supply water to the softener. This valve would preferably be normally in the open position. To prevent water damage by water leaking from this supply line, a water leak detector may be placed on the floor near the water softener. This leak detector is also capable of sending a radio signal if water is detected on the floor. If water is detected by the wireless leak detector 105, valve A will close to cut off water supply to the softener. An audible alarm may also be added to warn the user of the possible leak. In this embodiment, valve B will function in the same way as the valve described in FIG. 7. The valve will remain in the default closed position and will open when radio signal is transmitted from the plug in sensor to the receiver 5.

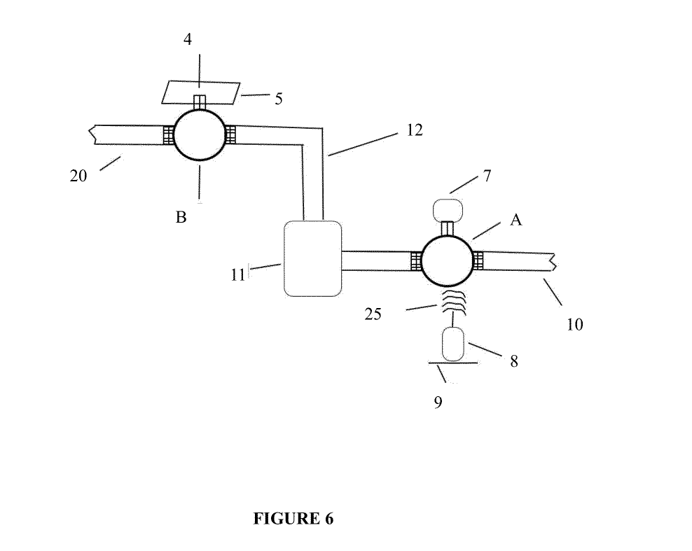

FIG. 6 illustrates the use of two valves being installed in the main supply line having water softening device 11, motorized valve A and a motorized valve B. FIG. 6 further illustrates valve stem 7 connected to motorized valve A, sensing device 8, ground or floor 9, radio signal 25, radio signal receiver 5, valve stem 4 connected to motorized valve B, and house water supply 20. As shown in FIG. 6, inlet water line 10 supplies water to motorized valve A which is normally in the open position. Water from valve A is delivered to the water softening device 11, soft water from the water softening device then goes through the water line 12 and feeds the motorized valve B which is normally in the closed position. Valve B opens only if the building is occupied as sensed through motion detectors. In this way, the default position of the main water line motorized valve B remains closed and therefore leaks are prevented from occurring when the building is unoccupied unlike in the prior art where leaking water must first be sensed and the system shuts off the water supply only thereafter.

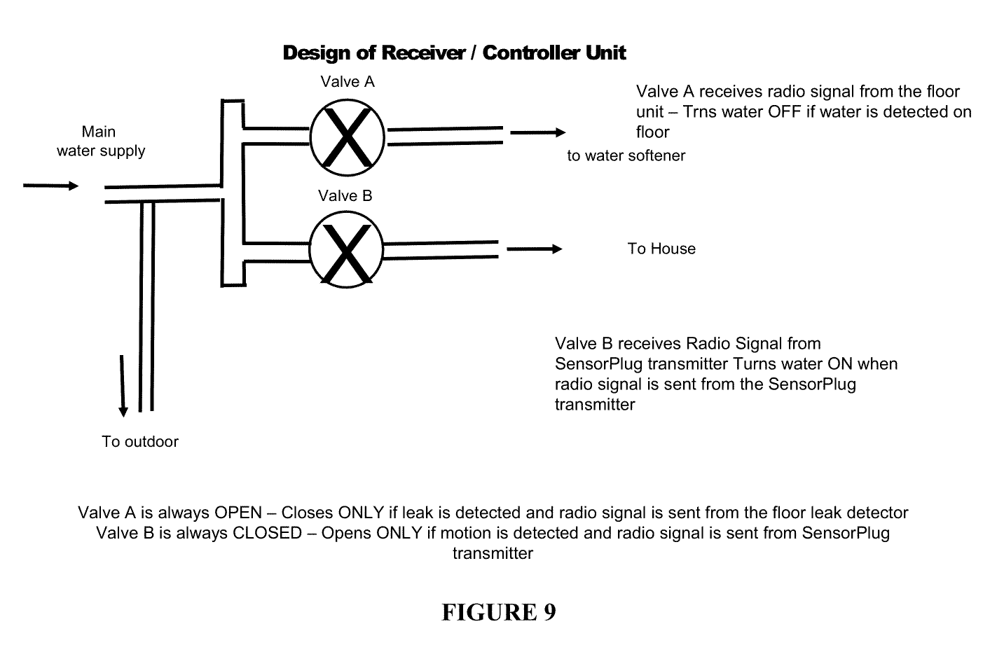

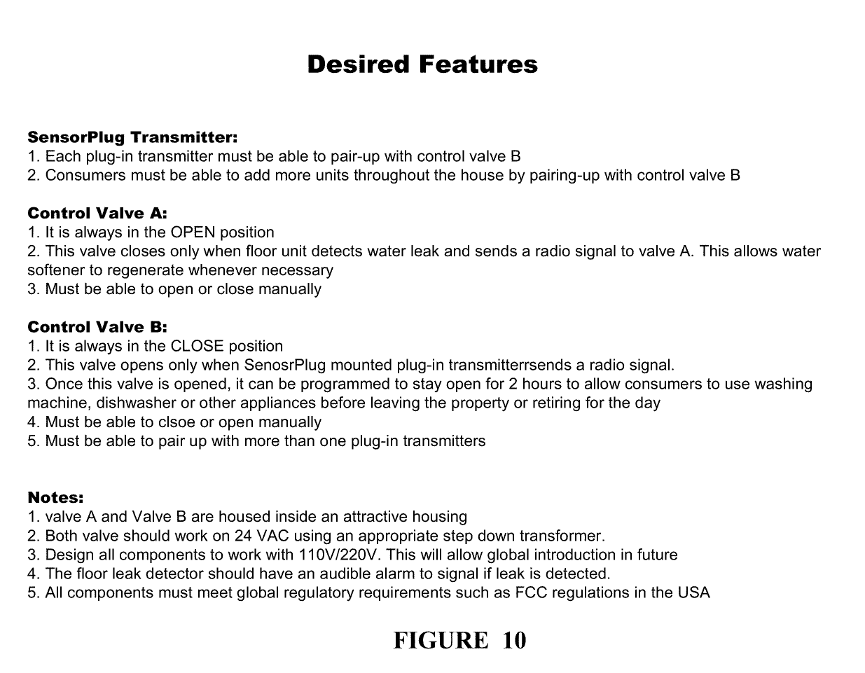

FIG. 9 illustrates another embodiment of the present invention where a dual valve system may be implemented in buildings needing a water softening device 11. In this embodiment, the main water supply line may be split into two separate lines, with one line leading directly to valve A and a second line leading to valve B. Motorized valve A may be designed such that it leads only to the water softening device 11 and remains in the open position unless a leak is detected in its vicinity, in which case a radio signal would be sent for motorized valve A to close. Motorized valve B would remain always in the closed position except when it receives radio signal from one or more motion activated electrical outlet devices 100 or device 103 indicating that the building is occupied. In this way, a building is kept protected from unmonitored leaks during periods of absence and/or non-activity within the building.

In another embodiment, if a single valve system is preferred in buildings using a water softening device 11, the valve A can remain open for a predetermined amount of time in the night when regeneration occurs or is likely to occur, depending on the type of water softening device used. A leak detector may be used in conjunction with this single valve as described in previous embodiments.

The motion sensors used in the present invention are preferably motion activated radio signal transmitting devices capable of activating water supply hardware mounted in the water supply line using radio frequency signals.

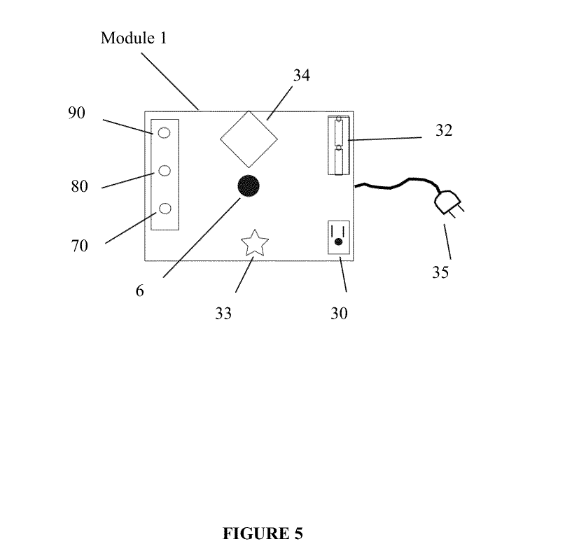

FIG. 5 shows an electronic module 1 for buildings not equipped with water softening devices. Module 1 contains the electronic and mechanical components necessary to receive radio signals transmitted by one or more motion activated electrical outlet devices 100. Module 1 may be energized by providing an electrical input 35 in the desired voltage. A battery-powered back up unit 32 may also be used to energize module 1. This module contains the necessary components and circuitry to energize and operate the motorized valve stem 4 whenever radio signals are received. Module 1 is used to facilitate pairing of one or more remotely located motion activated electrical outlet devices 100. This process is implemented by device 90. The process of pairing establishes a fixed communication link between each motion activated electrical outlet device 100 and receiving device 5. This prevents the motorized valve from mistakenly sensing a wireless signal from a transmitter uninvolved in the motion detection water shut-off system. Electrical outlet 30 is provided so that the motion activated electrical outlet device can be plugged in for pairing with the control unit.

Light emitting Diode (LED) lights 70 and 80 are provided for the user to confirm pairing has been completed for each motion activated electrical outlet device 100 or device 103. In use, a motion activated electrical outlet device 100 or 103 may be plugged into an electrical outlet in the building or into outlet 30 and next the receiving device is turned on. LED light 70 begins to blink and continues to blink until pairing has been successfully accomplished as indicated by a green LED light 80, for example.

Component 33 in module 1 of FIG. 5 is a Wi-Fi enabled signal receiving device to enable remote communication via smart phone, laptop, CPU or other electronic device such as a remotely located switch which functions to energize the motorized valve.

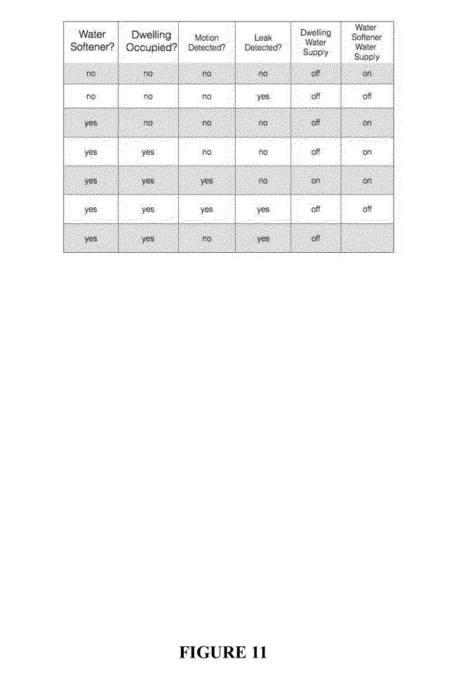

FIG. 11 illustrates the factors and conditions involved in controlling the motorized valve of the present invention. These factors may also be used as part of the logic followed by circuitry of the system controlling the motorized valve. For example, in a first step, the system of the present invention must know whether a water softening device 11 is implemented in the plumbing of the building. If no, the system in step 2 determines whether the building is occupied by the transmission of radio signal from one or more devices 100 or 103 to a receiver 5 integrated with the motorized valve 6. If no radio signal is detected, the motorized valve 6 remains closed. If radio signal is detected, the control circuitry allows the motorized valve 6 to open from the closed position for a predetermined amount of time, such as two hours, so that the building can be used for normal water use. In step 3, a determination is again made if radio signal is detected by receiver 5 after expiration of the predetermined amount of time where the motorized valve is open. If no radio signal is detected, the control circuitry allows the motorized valve 6 to default back to the closed position. If radio signal is again detected indicating that the building is occupied and in use, the main water motorized valve 6 is kept in the open position for a predetermined amount of time. This second predetermined amount of time can be the same or different from the first predetermined amount of time, depending on user preferences. For example, if the first predetermined amount of time is set to two hours, the system can be designed to such that the valve 6 is kept open for another 30 minutes, 10 minutes or 5 minutes.

If in the first step, a water softening device 11 is detected, then the system will move on to step 2 which is to determine whether the building is occupied or not. The outcome of step 2 will control motorized valve B, which opens and closes based on occupancy or activity within the building. Step 3 will follow in buildings using a water softening device, which will control motorized valve A which leads to the water softening device. Motorized valve A remains in an open position unless a leak is detected in the vicinity of the water softening device. If a leak is detected, a wireless signal is sent to the wireless receiver. The control circuitry is then designed to move the motorized valve from an open position to a closed position so that the detected leak can be minimized.

In one embodiment of the invention, there may be a temporary override of the shutoff feature in the case where the occupant has left the building, but has started the dishwasher or washing machine while away. The override feature may also work well when the user has left the home, but is watering the lawn or needs to keep the water supply available for outside lawn services at a point later on in the day or week. The override feature may be controllable from a wireless device such as a smart phone, or can be controlled by pressing a button on an outdoor faucet or inputting a code into a home monitoring system, for example.

In another embodiment of the present invention, the water shut off device does not require radio frequency to open or close a motorized valve and instead may be hard wired to the valve.

The present invention may be designed to function effectively in the case of a power outage. Accordingly, the present invention includes wireless signal transmission devices which may not need to be plugged into an electrical outlet but instead are designed to be battery-powered. The motorized valve may also be powered by a battery supply.

In one embodiment of the invention, the water turn on/off system may be installed to replace the conventional manual shut-off valve while preserving the ability to manually actuate the valve. Such a device will minimize property damage caused by broken or frozen water lines while the building is not occupied or has limited activity.

The present invention may be suitable for single family dwellings, single unit commercial spaces, and multi-unit dwellings and commercial spaces.

One of the many advantages of the present invention over the prior art is the ability to provide plug in transmitters which can be easily moved from one location to another without the user having to perform any electrical work. The device may be sold as separate units or in a kit along with the components necessary to convert the user's existing valve to a motorized valve in communication with the one or more devices 100 or 103. During installation, the motor may be easily attached to the main water valve by either the homeowner or a technician. First, the water line is closed or turned off to prevent water from exiting the pipes during installation. Next, the motorized valve is secured in place either mechanically such as a screw and threading attachment means or by soldering it in place.

While several particular forms of the invention have been illustrated and described, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A system for preventing leaks in the plumbing pipes and fixtures of a building, comprising:
a motorized valve connected to a water supply line such that the water flows through the motorized valve when the valve is in an open position,
one or more motion-activated wireless transmitters which transmit a wireless signal to a controller, the controller being capable of receiving wireless signals from the one or more transmitters and the controller being electrically coupled to the motorized valve, and
a power supply source for providing power to the one or more motion activated transmitters, the controller and the motorized valve.

2. The system of claim 1, wherein the motorized valve remains in the closed position until the one or more motion-activated wireless transmitters transmit a wireless signal to the controller upon sensing motion in the building, whereby when the controller receives the wireless signal from the one or more transmitters, the motorized valve moves from the closed position to an open position.

3. The system of claim 2, wherein after the motorized valve moves to the open position, the valve remains in the open position for a predetermined amount of time.

4. The system of claim 3, wherein after the motorized valve has remained in the open position for the predetermined amount of time, the valve closes unless the controller receives wireless signal from the one or more motion activated wireless transmitters.

5. The system of claim 1, further comprising a second motorized valve.

6. The system of claim 1, further comprising a water softening device.

7. The system of claim 1, wherein the controller further comprises a Wi-Fi-enabled receiving device to enable remote communication with a smart phone, laptop, CPU or other electronic device.

8. The system of claim 1, further comprising a temporary override option which serves to keep the motorized valve in an open position regardless of the motion detected by the one or more motion-activated wireless transmitters.

9. The system of claim 3, wherein the predetermined amount of time is about 5 minutes to about 3 hours.

10. A device for controlling a motorized water valve, comprising:
a motion-activated device comprising a motion sensor, a radio signal transmitter and a power source connection such that when motion is detected by the motion sensor, the power source energizes the radio signal transmitter to transmit radio signal to a receiver integrated with the motorized water valve and the motorized water valve changes from a closed position to an open position.

11. The device of claim 10, wherein the motion-activated device further comprises at least one electrical socket which is energized by the power source.

12. The device of claim 11, wherein the radio signal transmitter is a separate unit which may be plugged into the electrical socket of the motion-activated device.

13. The device of claim 10, wherein the motion-activated device is powered by a battery or by an electrical wall outlet.

14. The device of claim 10, further comprising a means to turn on and off the radio signal transmitter.

15. The device of claim 10, wherein the motorized valve is programmed to remain open for a predetermined amount of time.

16. The device of claim 15, wherein the predetermined amount of time is about 5 minutes to about 3 hours.

17. The device of claim 10, further comprising a Wi-Fi-enabled receiving device to enable remote communication of the device using a smart phone, laptop, CPU or other electronic device.

18. The device of claim 10, wherein the device communicates wirelessly to at least a second motorized valve.

19. The device of claim 10, further comprising a temporary override option which serves to keep the motorized valve in an open position regardless of the motion detected by the motion sensor.

20. The device of claim 10, further comprising an additional sensor selected from the group consisting of a temperature sensor, a water leak sensor and a humidity sensor.
